(19) United States
(12) Patent Application Publication
(10) Pub. No.: US 2003/0212518 A1
(43) Pub. Date: Nov. 13, 2003

(54) System and method for quality performance evaluation and reporting

(75) Inventors: Conrad D'Alessandro, Skillman, NJ (US); Leonard D. Fantasia, Atlantic Highlands, NJ (US); Charles Masarik, Neptune, NJ (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Johnson & Johnson

(21) Appl. No.: 10/141,810

(22) Filed: May 9, 2002

(51) Int. Cl. G06F 19/00; G01N 37/00; G06F 17/60

(52) U.S. Cl. 702/84; 705/11

(57) ABSTRACT

A system and method for quality performance evaluation and reporting allows for easy entry of quality performance data via spreadsheet or other file format, or directly, into a quality performance system. Data elements are associated across data types, allowing searches to be performed on the entire corpus of quality performance data. A typical data may be displayed as well, allowing users to focus on problematic quality performance. Data in reports may be displayed graphically or in tabular form; printed or displayed on screen; and searched for once, periodically, or upon other triggers.

### FIELD OF THE INVENTION

This invention relates to the field of data processing applications, and in particular to a system and method for quality performance evaluation and reporting.

### BACKGROUND

In running an organization providing products or services, quality performance data regarding the products or services may be received by the organization from customers, affiliates, and internal sources.

There are many types of quality performance data, and each type may be collected in different ways by an entity or organization—through internal reviews or by receiving external comments or feedback. Quality performance data may include:

Product complaints—written or oral expressions from a customer alleging a deficiency in the product.

Customer support data—data regarding the provision of services to customer, e.g. to ensure the proper installation, safe and reliable operation, maintenance, technical consulting, or logistical backup for a product.

Repair support data—data regarding returned product evaluation, product repair, or product upgrade services.

Stability data—data regarding a product's ability to meet shelf-life specifications by remaining suitable throughout the shelf-life of the product or until an expiration date.

An organization also may have established procedures and practices regarding quality. Such established procedures or practices can include information from disparate sources: corporate procedures, quality policies, process specifications, site procedures, work instructions, blueprints, test methods, instrument accuracy specifications, operator manuals, material or finished goods specifications, or manufacturing instructions.

An organization may wish to monitor compliance with or deviations from established procedures/practices. The results of this monitoring are another source of quality performance data; these types of quality performance data may track deviations that are planned (temporary change data) or those that are unplanned (non-conformances). A non-conformance or other compliance issue is rectified by means of a corrective action, which will be assigned an associated completion date. Before a corrective action has been assigned a completion date it is known as an uncommitted corrective action. When a completion date is extended it is known as a delayed/rescheduled corrective action. If the date is past and the corrective action is not complete, it is an overdue corrective action. Information regarding the corrective action is yet another type of quality performance data.

A change control system may be used to define the requirements for and to document changes to raw materials, suppliers, equipment, facilities, utilities, and documents (including specifications, analytical methods, manufacturing procedures, cleaning procedures, packaging, and labeling procedures). Temporary changes are managed in the change control system; the tracking of these changes yields another type of quality performance data.

When a product is being launched, there may be an associated schedule, including the events and milestones up to launch (and deadlines for each of these) and post-launch procedures and milestones. Whether those deadlines are being met is another form of quality performance data.

As described, there are many types of quality performance data. Previously, data on each different type of quality performance data, if it is tracked, is stored using a different system. Systems used include paper logbooks and computer spreadsheets. Storage is in many different formats, depending on the system used and the quality performance data being tracked. Quality performance data can be looked at and analyzed, but no system exists which tracks two or more different types of quality performance data for a given product, division, or other common element. Additionally, no system exists which initiates reporting if there is an a typical situation (a trend which is outside of set parameters for normality.) It would be useful for there to be a method to track trends in quality performance data and quality performance data.

### SUMMARY OF THE INVENTION

In accordance with the present invention, a system and method is provided which allows for collection of quality compliance data, storage of such data, scanning of the data to identify a typical trends and values, provide early warning of quality compliance risks, generate reports of a typical situations in graphic and tabular format, and display quality compliance data.

Data types are defined, and elements of these data types are defined. In addition, the elements can be grouped together in order to allow for searching across data types in those elements. For example, all quality data which deals with a specific product or all events with a critical date during a certain period may be searched for.

Other aspects of the present invention are described below.

### BRIEF DESCRIPTION OF THE DRAWINGS

The foregoing summary, as well as the following detailed description of presently preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an expemplary network environment according to one embodiment of the invention.

FIG. 2 is a block diagram of a computing device according to one embodiment of the invention.

FIG. 3 is a flow chart illustrating the flow of a search according to one embodiment of the invention.

FIG. 4 is a flow chart illustrating the flow of a typical reporting according to one embodiment of the invention.

### DETAILED DESCRIPTION OF PREFERRED EMBODIMENTS

Overview

The system and method of the present invention provide a coherent system, implemented on one or more computers, for defining parameters for the quality performance data, accumulating and storing quality performance data, and generating reports and displays of the quality performance data across multiple data types, and automatic reports and displays of a typical quality performance trends.

Exemplary Operating Environment

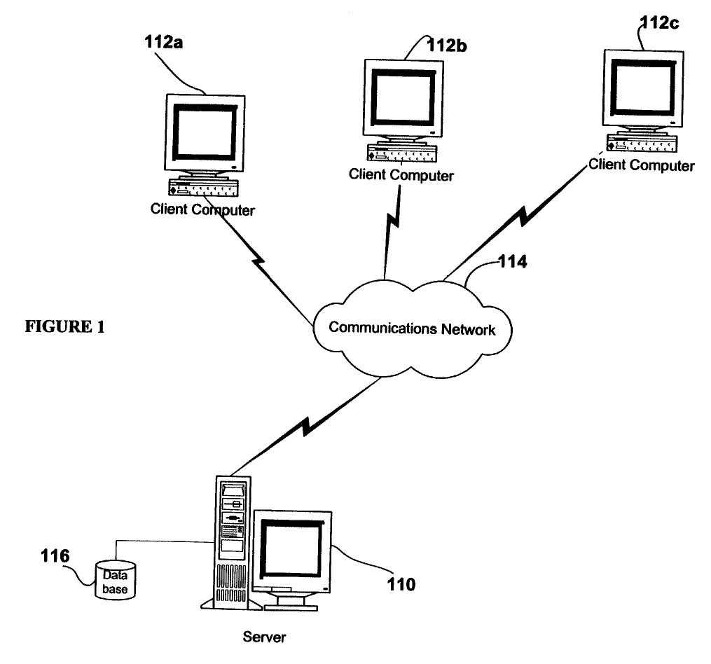

The system and method of the present invention can be deployed as part of a computer network, and that the present invention pertains to any computer system having any number of memory or storage units, and any number of applications and processes occurring across any number of volumes. Thus, the invention may apply to both server computers and client computers deployed in a network environment, having remote or local storage. FIG. 1 illustrates an exemplary network environment, with a server in communication with client computers via a network, in which the present invention may be employed. As shown, a server 110 is interconnected via a communications network 114 (which may be a LAN, WAN, intranet or the Internet) with a number of client computers 112a, 112b, 112c, etc. In a network environment in which the communications network 114 is the Internet, for example, the server 110 can be a Web server with which the clients 112 communicate via any of a number of known protocols such as hypertext transfer protocol (HTTP).

Each client computer 112 and server computer 110 may be equipped with various application program modules, other program modules, and program data and with connections or access to various types of storage elements or objects. Thus, each computer 110 or 112 may have performance data. Each computer 112 may contain computer-executable instructions that carry out the quality performance evaluation and reporting of the invention. It will be appreciated that the network connections shown are exemplary and other means of establishing a communications link between the computers may be used. The quality performance data is stored in database 116 that is coupled to server 110. Client computers 112 may be affiliate or entity computer systems that collect, maintain, and forward data that is stored in database 116.

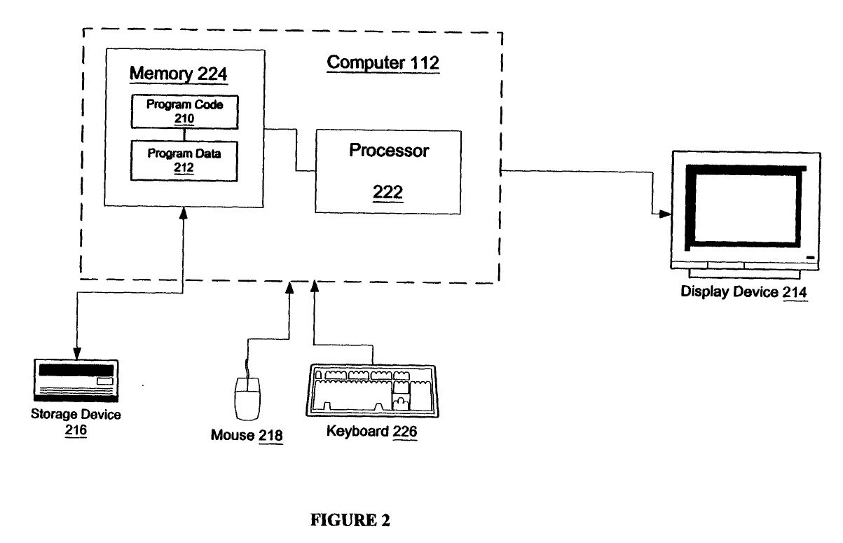

FIG. 2 provides a block diagram of an exemplary computing environment in which the computer-readable instruction of the invention may be implemented. The further details of such computer systems as 110 and 112 (FIG. 1) are shown in FIG. 2. Generally, computer-executable instructions are contained in program modules such as programs, objects, data structures and the like that perform particular tasks. Those skilled in the art will appreciate that the invention may be practiced with other computer system configurations, including multi-processor systems, network PCs, minicomputers, mainframe computers and so on. The invention may also be practiced in distributed computing environments where tasks are performed by remote processing devices that are linked through a communications network.

FIG. 2 includes a general-purpose computing device in the form of a computer system 112 (or 110), including a processing unit 222, and a system memory 224. The system memory could include read-only memory (ROM) and/or random access memory (RAM) and contains the program code 210 and data 212 for carrying out the present invention. The system further comprises a storage device 216, such as a magnetic disk drive, optical disk drive, or the like. The storage device 216 and its associated computer-readable media provides a non-volatile storage of computer readable instructions, data structures, program modules and other data for the computer system 220.

A user may enter commands and information into the computer system 220 by way of input devices such as a keyboard 226 and pointing device 218. A display device 214 such as a monitor is connected to the computer system 220 to provide visual indications for user input and output. In addition to the display device 214, computer system 220 may also include other peripheral output devices (not shown), such as a printer.

Defining Parameters for Quality Performance Data

According to one embodiment of the invention, the system accepts quality performance data. Quality performance data may be of varying types—each data type has specific elements associated with it.

For example, a complaint should include information about which product the complaint regarded. Therefore, one element of a complaint is a product identification element. When a complaint is entered into the system, some or all of the complaint elements are included. In one embodiment, numerous different types of quality performance data are supported including complaints, non-conformances, corrective actions, change control information, compliance to stability protocols, and product launch readiness information. These are described below.

Data may be entered in collective form. For example, if complaints are collected and entered into the system of the invention once per week, the complaint data type supports these aggregated complaint data. In such cases, single complaints may also be entered, by using the element which specifies the number of complaints.

In the illustrative embodiment of the invention, the following data types and elements are included:

Complaint Data

Complaint data, describing complaints received about products, comprises the following elements: product number/name; product family; information regarding the type of complaint (including a class and category/sub-class in the class); site (if applicable); number of complaints being entered; number of complaints closed late; and number of complaints filed late.

In another embodiment, the system can accept data on each complaint separately.

Non-Conformance Data

Non-conformance data is data regarding unplanned deviations from established procedures/practices. Such data comprises the following elements: product number/name; product family; information regarding the type of non-conformance (including a category designation); site; disposition; and information regarding the cause of non-conformance (including a category designation).

Change Control Data

Change control data is data about planned deviations from established procedures/practices. Change control data comprises: product number/name; product family; information regarding the type of change control including a category designation); severity; site; time period; and number of changes.

Corrective Action Data

Corrective action data is data regarding actions taken to rectify a compliance issue. Corrective action data comprises: source (of the request for corrective action); a unique identification number for the corrective action; product number/name; product family; commit date (date by which the corrective action should be finished); revised commit date (revisions to commit date); and actual completion date.

Product Launch Readiness Data

Product launch readiness data describes the parameters of a planned product launch. Product launch readiness data comprises: product number/name; launch time period; and checklist items (items which must be accomplished to launch) and associated due dates.

Compliance to Stability Protocol Data

Compliance to stability protocol data tracks the ability to meet performance requirements throughout product shelf life. Compliance to stability protocol information tracks problems with adherence to the stability protocol including: product number/name; date of problem; site of origin of product; problem observed; number of units of product involved in the problem.

Most of the elements of each type of quality performance data are optional; some will have limits on their values (e.g. number of complaints must be non-negative). Other quality performance data types or elements of these types may be supported in other embodiments. For each type of quality performance data, data elements (such as those listed above) can be defined.

When the parameters for data types and elements are being defined, it is important that associations are made between like elements in different data types. For example, product number/name is an element of each of the exemplary data types listed above. An information element specifying a site associated with a quality performance data is an element of some, but not all of the data types listed. Not only can these very similar data types be associated, but so can others—for example, commit dates for corrective actions and dates associated with checklist items for product launches may be grouped, along with other elements, as elements which refer to deadlines. Because the definition of sets of grouped elements are made as part of the definition process, cross data-type reporting becomes possible, as described below.

Accumulating Quality Performance Data

Users accessing the system must be able to enter data. Data may be entered into the system from a spreadsheet or other file of a specified format. The user enters the location of the data, and the system will process the data and store it. Data may also be entered manually via a keyboard or other user interface with prompts to the user. When data has been entered (either from a file or manually), a check is performed to ensure that all of the mandatory data elements have been entered and that any value which has been entered for an element is within the ranges set for the data element (if any) or is of the type which has been defined for the data element (if any). Conversion to standard field formats is performed, to standardize date formats, for example. Where duplicate records can be identified, duplication is checked for and the user alerted or, in another embodiment, duplication is automatically eliminated.

Reporting and Displaying Performance Data of Multiple Types Using a Common Element

In order to provide users with information regarding quality performance data, the system allows the user the ability to review data on-line. In one embodiment, user access to the system is provided via a user interface including a display area and pull down menus offering users different data viewing and reporting options.

Users may choose to display only one type of data. For example, the user may request all complaints. This data may be further limited with reference to the elements of the data type. For example, all complaints received in a given month may be requested. Data being displayed may be sorted on date or on other parameters, as requested by the user. Data may be displayed in a table, or graphically, depending on the user's request, and report displays may be viewed on screen or viewed through the use of intermediate files stored by the system or emailed to users.

In addition to reporting data in only one data type, however, users are provided with the ability to create reports of data of many data types, by selecting specific data to view from the entire corpus of quality data. This is possible because different data types may have elements from among a single set of grouped data elements. So, by using the correct set of grouped data elements, users are able to search among different data types by site, by product, by product family, by deadline, or any combination of these options.

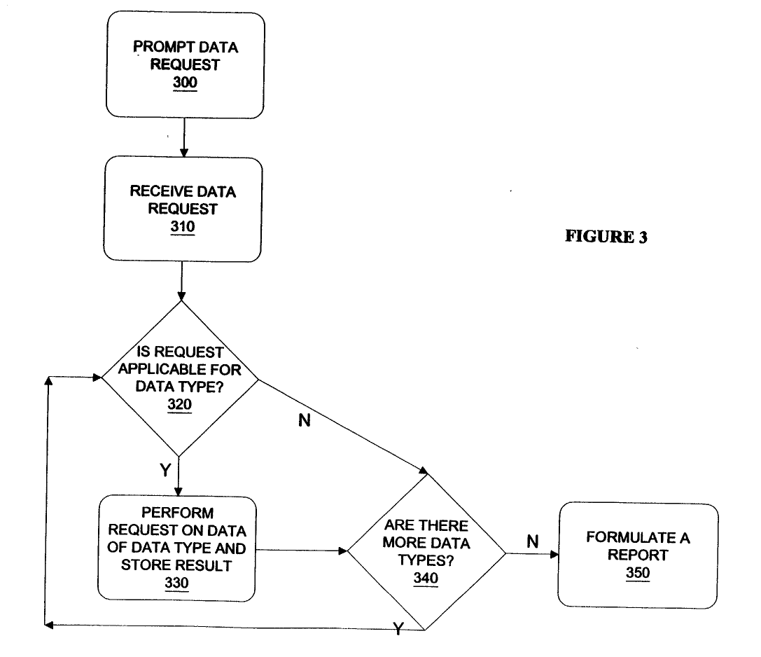

With reference to the flow chart of FIG. 3, the system prompts the user to specify a request, including a set of grouped data elements (such as “site” or “deadline”, as described above) and a value or range to search for in the data elements included in that group 300. When the user does, the system receives that request 310. For each data type, the system determines whether the request is applicable for the data type 320. If the request is applicable to that data type (if the element involved in the request is an element of that data type), the system performs the request on data of that data type and temporarily stores the results 330. When that is done, or if the request was not applicable, the system determines whether there are any more data types to consider 340. If there are, the system determines whether the request is applicable to the next data type (step 320) and continues from there. If there are not, the system formulates a report of the temporarily stored data 350.

In this way reports can be formulated which include multiple data types, even if not all of the elements in the set of grouped elements requested exist in all the data types. The request received by the system in step 310 may involve more than one set of grouped elements—it can be a combination of requests conjunctively (data which are included in the results of request 1 and also in the results of request 2), disjunctively (data which are included in the results of request 1 and the results of request 2), or negatively (all data not included in the results of the request). For example, instead of requesting all quality data entered for a given product family, it may request all quality data entered for a given product family in a specific month, not including complaints. Or all quality data may be requested for two specified product families.

Again, data being displayed may be sorted on date or on other parameters, as requested by the user, and graphical and tabular reports are available. Report displays may be viewed on screen or viewed through the use of intermediate files stored by the system or emailed to users. A user may also request that a report be run on a periodic basis or on any other trigger which the system can perceive (introduction of new data; opening of application, etc.)

Reporting and Displaying Performance Data of Multiple Types Using a Common Element

A typical reporting is also provided by the system. For example, all available complaint data may be evaluated on a month-by-month basis, and months with an increase of more than 10% more complaints than the previous month are highlighted. Multi-variant assessments that take into account the compounding effect of quality activity and performance associated with more than one measurement are provided for.

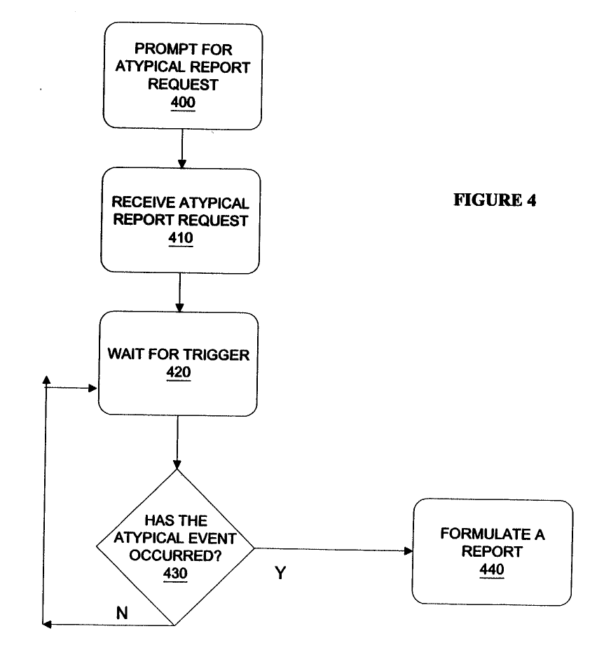

With reference to the flow chart of FIG. 4, the system prompts the user to input an a typical report request in step 400 and receives the request in step 410. The request will contain an a typical condition, which the quality performance data is to be monitored for, and a triggering event. The system according to one embodiment of the invention may be running continually, as a background process, or as an application which is started by a user, among other possibilities. The triggering event of the request specifies when the data will be evaluated to see if the a typical condition is present. Either the request is to be run once at a given time, or the request is to be run on a periodic basis with a specified period, or the request is to be run every time the program is restarted. The system waits for the triggering event 420, and then evaluates whether the a typical condition has occurred 430. If it has not, the system waits for the next triggering event 420. If the a typical condition has occurred, a report will be created and provided to the user 440. The provision of the report to the user will be done in a way specified in the request (or according to a default if none was specified.) The report may be displayed, emailed to a user, or a message may be sent to the user or displayed indicating that the report is available. In this way, a typical conditions may be monitored.

Just as searches may be done using sets of grouped events, so may a typical conditions be done on groupings—for example, an request may ask that the number of deadlines for a given month be monitored and that if any month has more than a threshold number of deadlines, that situation be reported as a typical. A request may also ask that if deadlines for any month rise more than 10% over any other month, that situation be reported. In this way, all the quality performance data may be used to monitor work flow, problems, or other quality issues.

In one embodiment, data used for reports and displays is from a 13-month rolling horizon, allowing 13 months of data to be input and used. Data is backed up regularly, and data which is older than 13 months is archived.

### CONCLUSION

In the foregoing description, it can be seen that the present invention comprises a new and useful system and method for quality performance evaluation and reporting. It should be appreciated that changes could be made to the embodiments described above without departing from the inventive concepts thereof. It are understood, therefore, that this invention is not limited to the particular embodiments disclosed, but it is intended to cover modifications within should be spirit and scope of the present invention as defined by the appended claims.

What is claimed is:

1. A method for quality performance evaluation and performance comprising:
defining at least two types of quality performance data, each of said types comprising at least one associated data element;
defining at least one set of said data elements, each of said at least one set of data elements comprising at least one associated data element from each of at least two types from among of said at least two types of quality performance data;
accepting quality performance data of said defined types;
accepting a search request comprising at least one set of said data elements and search parameters; and
searching for result data matching said search request parameters in each of said elements of said at least one set of said data elements.

2. The method of claim 1, where said search request further comprises a typical report commands from a user specifying at least one threshold value for a typical data, and where said step of searching for result data comprises searching to determine whether said quality performance data exceeds said threshold values.

3. The method of claim 1, where said step of accepting quality performance data of said defined types comprises extracting said quality performance data from a file of data.

4. The method of claim 1, where said step of accepting quality performance data of said defined types comprises accepting user input of quality performance data.

5. The method of claim 1, where at least one of said associated data elements includes an associated type designation for said element, and where said step of accepting quality performance data comprises:
identifying the data element being accepted; and
checking, if said data element being accepted includes an associated type designation, that said data element is of said associated designated type.

6. The method of claim 1, where at least one of said associated data elements includes an associated range values for said element, and where said step of accepting quality performance data comprises:
identifying the data element being accepted; and
checking, if said data element being accepted includes an associated range value designation, that said data element is within said associated range.

7. The method of claim 1, where said search request further comprises a search trigger, and where said step of searching for result data occurs when said search trigger occurs.

8. The method of claim 7, where said search trigger occurs periodically after is the lapse of a certain period of time.

9. The method of claim 7, where said search trigger occurs when a computer application implementing all or part of the method is initiated.

10. The method of claim 1, further comprising:
accepting display commands from a user; and
creating a display of result data based on said display commands.

11. The method of claim 10, where said step of creating a display of result data comprises:
determining whether a tabular display or a graphic display was requested by a user; and
creating a tabular display or a graphic display of quality performance data based on said user request.

12. The method of claim 10, where said step of creating a display of quality result data comprises:
determining from user commands how said display should be output; and
outputting said display based on said user commands.

13. The method of claim 12, where said outputting step comprises at least one of the following:
displaying said display on a screen;
printing said display;
storing said display to a file;
storing said display to a file and emailing said file to at least one prespecified recipient.

14. A computer-readable medium bearing computer-readable instructions for
defining at least two types of quality performance data, each of said types comprising at least one associated data element;
defining at least one set of said data elements, each of said at least one set of data elements comprising at least one associated data element from each of at least two types from among of said at least two types of quality performance data;
accepting quality performance data of said defined types;
accepting a search request comprising at least one set of said data elements and search parameters; and
searching for result data matching said search request parameters in each of said elements of said at least one set of said data elements.

15. A system for quality performance evaluation and performance comprising implemented on at least one computers, comprising:
type defining means for defining at least two types of quality performance data, each of said types comprising at least one associated data element;
element defining means for defining at least one set of said data elements, each of said at least one set of data elements comprising at least one associated data element from each of at least two types from among of said at least two types of quality performance data;
data input means for accepting quality performance data of said defined types;
search request input means for accepting a search request comprising at least one set of said data elements and search parameters; and
search means for searching for result data matching said search request parameters in each of said elements of said at least one set of said data elements.

16. The system of claim 15, further comprising:
display means for displaying result data.

17. The system of claim 15, further comprising:
printing means for printing said result data.

18. The system of claim 15, further comprising:
storage means for storing said result data.

19. The system of claim 15, further comprising:
emailing means for emailing said result data.
